(19) United States
(12) Patent Application Publication
(10) Pub. No.: US 2024/0026696 A1
(43) Pub. Date: Jan. 25, 2024

(54) Concrete Compaction System with Feedback on Compaction State

(71) Applicant: Wacker Neuson Produktion GmbH & Co. KG, Reichertshofen (DE)

(72) Inventors: Christian Lange, Ingolstadt (DE); Rudolf Berger, Gruenwald (DE); Patrick Diller, Hohenwart (DE); Stefan Pfetsch, Munich (DE); Christian Glanz, Dachau (DE); Alto Weiskopf, Altomuenster (DE)

(21) Appl. No.: 18/225,380

(22) Filed: Jul. 24, 2023

(30) Foreign Application Priority Data
Jul. 25, 2022 (DE) 10 2022 118 543.5

(51) Int. Cl. E04G 21/08; B01F 31/00; B01F 33/501; B28C 5/48; B01F 35/32; B01F 35/22

(52) U.S. Cl. CPC E04G 21/08; B01F 31/70; B01F 33/5011; B28C 5/485; B01F 35/3204; B01F 35/2202; B01F 2101/28

(57) ABSTRACT

A concrete compaction system includes an unbalance exciter for concrete compaction, a compaction detection device for detecting progress of the compaction in the concrete, and a vibration device for generating a haptic feedback when a prescribed progress of the compaction has been detected by the compaction detection device. An electric motor may drive the unbalance exciter and may be powered by an electric power supply and a converter device for converting an electric current from the electric power supply to a drive current for the electric motor. The compaction detection device may comprise a measurement device for measuring the current drawn from the electric motor. The compaction detection device may also comprise an evaluation device for evaluating the current drawn measured by the measurement device, for determining therefrom the progress of the compaction in the concrete, and for detecting whether a prescribed progress of the compaction has been achieved.

### BACKGROUND OF THE INVENTION

### 1. Field of the Invention

The invention relates to a concrete compaction system.

### 2. Description of the Related Art

Concrete compaction systems, in particular so-called internal vibrators, are known. They have an unbalance exciter arranged in a so-called vibrator head, which is immersed in the still flowable concrete to be compacted in order to compact it by introducing vibrations.

The unbalance exciter is usually driven in rotation by an electric motor which is also arranged in the vibrator head. For this purpose, the electric motor must be supplied with a suitable current, in particular with a suitable voltage and a suitable frequency. For this purpose, a frequency converter is connected upstream, which converts the current supplied in a suitable manner. The electrical power supply can be provided via the public power grid or alternatively the power network available at a construction site.

In the more recent past, however, rechargeable battery technology has developed to such an extent that the electrical power supply can also be provided by means of an electrical energy storage device (rechargeable battery).

DE 10 2018 118 552 A1 discloses a supporting device with energy storage device and electrical converter. The supporting device can be designed in the form of a backpack and comprise a rechargeable battery and a converter, in order, for example, to supply an internal vibrator with suitable electrical current.

The internal vibrator itself comprises an operating hose, on which the vibrator head is fastened and which can be held by the operator in order to immerse the vibrator head in the concrete to be compacted. The electrical supply lines to the electric motor in the vibrator head also run inside the operating hose. Accordingly, the operating hose also serves as a protective tubing. At the transition between the end of the operating hose and the connecting cable leading to the frequency converter, there is a switch with which the operator can activate and deactivate the internal vibrator.

When using the internal vibrator during the carrying out of a compaction operation, the duration and frequency of immersion are based on the experience of the operator. In particular, for inexperienced users, it can be difficult to determine the correct compaction duration. If the concrete is compacted for too short a time, air bubbles or alternatively gravel pockets remain in the concrete that are not filled with cement paste. If, on the other hand, the concrete is compacted for too long, the concrete mix becomes unmixed, wherein large and heavy components sink to the bottom and shrinkage cavities can form on the upper surface.

Due to the ambient conditions on construction sites (noise, dirt, concrete), it is difficult to provide the user with information about a sufficient degree of compaction. Optical and acoustic signals are often not perceived.

GB 1 097 651 A describes a system for switching off the current delivery to an internal vibrator as well as for visual signaling by means of a light source when the consumption of current (measured at one phase of the motor), after the immersion process, falls below a certain threshold value. In this case, however, the internal vibrator must be pulled out of the concrete in the switched-off state. In this case, however, the concrete is less flowable, making it more difficult to pull the internal vibrator out. In addition, air pockets can form anew, reducing the quality of the concrete.

### SUMMARY OF THE INVENTION

The invention is based on the task of specifying a concrete compaction system, in particular an internal vibrator, in which the operator can obtain clear feedback relating to a concluded compaction or alternatively to the progress of the compaction.

The task is solved by a concrete compaction system that includes an unbalance exciter for concrete compaction, a compaction detection device for detecting progress of the compaction in the concrete, and a vibration device for generating a haptic feedback when a prescribed progress of the compaction has been detected by the compaction detection device.

The unbalance exciter is used for immersion in the concrete to be compacted. When the unbalance exciter is operated, oscillations are generated which cause compaction of the still flowable concrete in a manner that may be known per se.

During the compaction process, the progress of the compaction is monitored. In particular, this involves the state of compaction or alternatively the degree of compaction in the concrete. The longer the unbalance exciter compacts the concrete at the location in question, the greater amount of air bubbles can be released. On the other hand, however, an over-compaction can also result in an unmixing of the components of the concrete, which must be avoided.

Various measures for determining progress of the compaction are known from the state of the art, for example, from GB 1 097 651 A. The consumption of current of an electric motor driving the unbalance exciter can be monitored, from which conclusions can be drawn relative to the progress of the compaction. From EP 1 165 907 B1 or alternatively WO 00/57000 A1, it is known to arrange acceleration sensors on the vibrator head, with which acceleration values of the vibrator head in the concrete to be compacted can be recorded, which enables conclusions to be drawn about the progress of the compaction. The disclosures of all of all of these documents are incorporated herein by reference in their entirety.

When a prescribed or alternatively predefined progress of the compaction is reached, which is to say, when the desired degree of compaction is achieved, a haptic feedback is generated which can be perceived haptically by the operator of the concrete compaction system. The haptic feedback thus represents a haptic feedback signal or alternatively a vibration signal that the operator can perceive even under harsh construction site conditions. This is, in particular, possible because the operator is in physical contact with components of the concrete compaction system, for example, via their hands or their back. The generation of a corresponding vibration as haptic feedback can be perceived by the operator, even if the operator wears hearing protection and works in a concentrated manner while being exposed to the vibrations causing the compaction.

The vibration device can generate, for this purpose, a corresponding vibration or modify an existing vibration. A combination of generation and modification of a vibration is also possible.

In one variant, the unbalance exciter is driven by an electric motor that draws its electrical power from an electric power supply. A converter device may be provided for converting an electric current for the electric motor drawn from the electric power supply. The compaction detection device may comprise a measurement device for measuring the current drawn from the electric motor, wherein the compaction detection device may also comprise an evaluation device for evaluating the current draw measured by the measurement device and determining therefrom the progress of the compaction in the concrete and detecting whether a prescribed progress of the compaction has been achieved. The measurement device can be used, in particular, for measuring the electrical power consumption.

With the aid of the measurement device and the evaluation device, the compaction detection device thus monitors the current draw, in particular the power use of the electric motor, which changes during the compaction process. The change goes hand in hand with the progress of the compaction because the concrete changes its consistency, in particular its viscosity, during compaction, which change requires corresponding reaction forces and torques to drive the unbalance exciter. The torques of the electric motor required to operate the unbalance exciter can be determined by the power use. Exceeding or alternatively falling below certain prescribed limits for power use can be used as a criterion for the progress of the compaction. Depending on the configuration of the evaluation device, limit values can be defined. It is also, however, to prescribe progressions or alternatively gradients which are characteristic for the progress of the compaction and for the achievement of a prescribed degree of compaction.

The result of the evaluation device, in particular the knowledge that a prescribed compression progress has been achieved, can then be suitably transmitted to the vibration device to generate the haptic feedback.

The unbalance exciter may be arranged in a housing, wherein an operating hose may be fastened to the housing for guiding the housing by an operator. The housing may typically be a so-called vibrator head, inside which the unbalance exciter and usually also the electric motor driving the unbalance exciter are accommodated. The combination of housing and operating hose corresponds to a typical internal vibrator, which can be guided by the operator by holding the operating hose.

The electrical power supply required for operation of the electric motor can be provided by means of power cables or alternatively power lines which run at least partially inside the operating hose and are connected, for example, to the converter device. The electrical power supply can then be provided by an electrical energy storage device (rechargeable battery) or a mains connection for connection to the public power grid or a building site power network.

Accordingly, the operating hose can also be a protective tubing for protection of the electrical supply lines to the housing when the electric motor is located in the housing.

In a preferred embodiment, the electrical power supply may comprise an electrical energy storage device. In particular, this can be a replaceable rechargeable battery.

The converter device may be designed to provide current to the electric motor at a prescribed voltage and/or frequency.

A switching device can be provided to switch the electric motor on and off. The switching device can be arranged between the energy storage device and the converter or between the converter and the electric motor. In particular, the switching device can be arranged at the end of the operating hose, opposite the housing containing the unbalance exciter, held at the other end of the operating hose. Thus, the switching device can be connected to the operating hose at one end, whereas the electrical supply cable to the unbalance exciter is routed at its other end.

The electrical energy storage device and the converter device may be arranged on a supporting device, wherein the supporting device comprises at least one strap for carrying the supporting device by a user. Such a supporting device is known, for example, from DE 10 2018 118 552 A1 and it U.S. counterpart US20200044206A1, the subject matter of each of which is hereby incorporated herein by reference in its entirety.

In particular, the supporting device may be configured in the manner of a backpack, such that the user carries the supporting device together with the energy storage device and the converter device on their back. A power cable then extends from the converter device to the operating hose or to the switching device provided on the operating hose.

The energy storage device can be exchangeably fastened to the supporting device. This allows the energy storage device to be switched out when exhausted and replaced with a fresh energy storage device.

Since, in this case, the operator is in physical contact with the concrete compaction system at two points, namely, firstly with their hands inasmuch as they are holding the operating hose or alternatively the switching device and secondly with their back inasmuch as they are carrying the supporting device, the vibration device can be designed to generate a haptic signal that the operator can perceive through this body contact (hand, back).

The vibration device for generating the haptic feedback may comprise at least one of the following features: a variation of the speed of the electric motor, a brief changing the rotational frequency of the electric motor followed by a return to the previous rotational frequency, reduction of the rotational frequency of the electric motor to zero, an abrupt change of the rotational frequency of the electric motor, a change of the direction of rotation of the electric motor, multiple changes in the direction of rotation of the electric motor, generation of a vibration that is perceptible by the operator during operation of the concrete compaction system, generation of a vibration at the supporting device, generation of a vibration at the energy storage device, generation of a vibration at the converter device, generation of a vibration at the operating hose, generation of a vibration at the switching device.

The vibration device can, in particular, thus effect a change in oscillation that can be perceived by the operator as a haptic signal. The changing of the rotational frequency of the motor leads to a change in the oscillation frequency at the internal vibrator, which can be perceived haptically by the operator, for example, when holding the operating hose.

The change in vibration can follow a pattern, for example, in the manner of Morse code. By way of example, the vibration and thus the haptic signal for the operator can be achieved by briefly increasing or decreasing the rotational frequency of the motor several times.

The change in rotational frequency of the motor can be brought about, in particular, by changing the frequency of the current coming from the converter or by changing the motor voltage.

In one variant, it is possible to reduce the rotational frequency of the electric motor to zero, which is to say, to a standstill. It can then be accelerated either in the normal direction of operation or in the opposite direction. The operator notices this by means of a tortional distortion in the guide hose.

Alternatively, the internal vibrator can also be actively decelerated, for example, by moving the inverter frequency to zero and/or by reversing the phase sequence.

It is likewise possible to generate a targeted vibration independently of the respective rotational frequency of the motor, similar to a vibrate alarm on a smartphone. For this purpose, the vibration device can also, for example, have its own unbalance exciter that is placed in a suitable position so that the vibration generated by its own unbalance exciter (which is smaller than the unbalance exciter used for concrete compaction) can be perceived by the operator.

The measurement device can be coupled to the energy storage device or to the converter device in order to measure the current or alternatively the power consumption. Accordingly, it may be expedient that the measurement device is also arranged on the supporting device, if the energy storage device and the converter device are arranged on a supporting device in the variant described above. It is also possible that the measurement device is integrated in the energy storage device and is used, for example, as part of the battery management system of the energy storage device. Modern rechargeable battery systems often comprise corresponding measurement devices to obtain information about the power use and thus about the capacity of the rechargeable battery. This information can be made available as part of the measurement device of the compaction detection device.

The evaluation device can also be integrated together with the measurement device and arranged in a suitable manner, by way of example, in the vicinity of the energy storage device or—if present—also on the supporting device.

In one variant, the evaluation device can be arranged in a mobile device, spatially separated from the energy storage device and from the converter device. The mobile device may be, for example, a smartphone, a tablet or a laptop.

The evaluation of the measurement results recorded by the measurement device may require a not inconsiderable computational capacity that is not available at the measurement device, the energy storage device or the frequency converter. In contrast, smartphones, laptops or tablets are readily capable of providing sufficient computational capacity. The required computational capacities depend, in particular, on the calculation model on which the detection of the progress of the compaction is based. If one assumes that power draw patterns are to be evaluated over a certain period of time, a great deal of data may be generated, requiring a greater computational capacity. It is also conceivable that the evaluation device also uses, at least in part, an artificial intelligence-based system to draw conclusions about the degree of compaction based on the patterns in power use that occur during concrete compaction.

The mobile device can, in particular, be moved independently of the energy storage device or of the converter.

A data transmission between the measurement device and the evaluation device can be provided for the back and forth transmission of data between the measurement device and the (possibly spatially remote) evaluation device. If the measurement device is integrated in the energy storage device (rechargeable battery), the data transmission can accordingly also be provided between the energy storage device and the evaluation device. The data concerns, in particular, the detection of the progress of the compaction or is used to determine the progress of the compaction.

A radio link can be used for the data transmission, for example, via Bluetooth.

The evaluation device can be provided in the mobile device described above or directly on the energy storage device or on the converter.

If the measurement device is provided in the energy storage device, the measurement device can send the data to the mobile device. Likewise, the data can also be collected in the converter, wherein the energy storage device can also be used as a gateway for data transmission to the mobile device, especially if it comprises facilities for data transmission.

In accordance with another aspect of the invention, method of compacting concrete comprises:
immersing an unbalance exciter into the concrete to be compacted;
compacting the concrete by actuating the unbalance exciter;
monitoring the progress of the compaction; and
generating a haptic feedback for an operator when the achievement of a prescribed progress of the compaction has been detected.

### BRIEF DESCRIPTION OF THE DRAWINGS

These and other advantages and features are elucidated with the aid of the FIGURE in more detail below by means of an example. Wherein:

FIG. 1 shows a concrete compaction system according to the invention in schematic representation.

### DETAILED DESCRIPTION

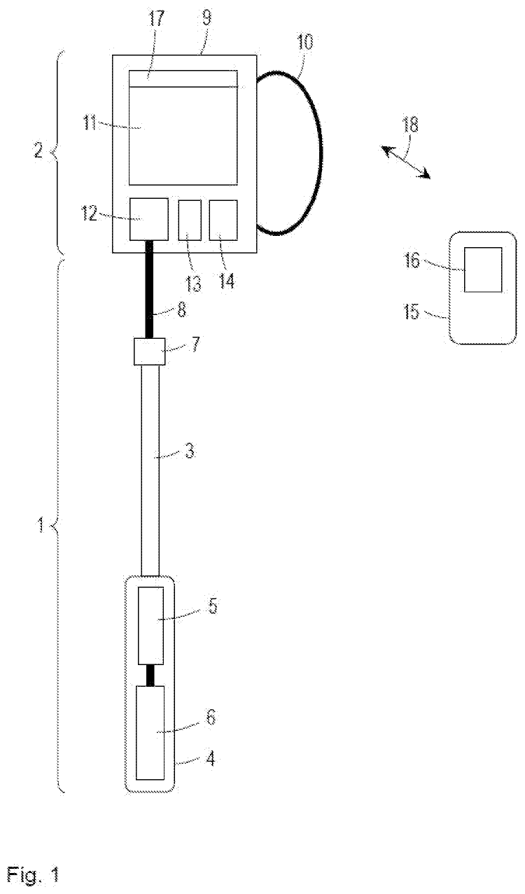

FIG. 1 shows a schematic representation of a concrete compaction system with an internal vibrator 1 and a portable energy device 2.

The internal vibrator 1 comprises an operating hose 3, at the one end of which a vibrator head 4 serving as a housing is attached. On the inside the vibrator head 4 is an electric motor 5 which drives an unbalance exciter 6 in rotation. The unbalance exciter 6 can be, for example, an unbalance shaft on which an unbalance mass is eccentrically mounted so that, when the unbalance shaft rotates, oscillations are generated which are introduced into the concrete to be compacted via the outer housing wall of the vibrator head 4. The assembly of such a vibrator head 4 with electric motor 5 and unbalance exciter 6 is known per se.

The operating hose 3 can comprise a length of several meters, so that the operator can also suspend the vibrator head 4, over a greater distance, in the concrete to be compacted during the compaction work. FIG. 1 is, moreover, not to scale and does not reflect the actual length of the operating hose 3.

A switching device 7 is attached to the end of the operating hose 3 opposite the vibrator head 4, via which switching device the electric motor 5 can be switched on and off. The switching device 7 can also serve as a connection point for a power line 8 (power cable). The electrical leads of the power line 8 are routed inside the operating hose 3 to the vibrator head 4, so that the operating hose 3 also takes on the function of a protective tubing.

At the end of the power line 8 opposite the switching device 7, a plug not shown in FIG. 1 may be provided in a manner known per se.

The plug may be plugged into the power device 2.

In the example shown in FIG. 1, essential parts of the power device 2 are arranged on a supporting device 9, which can be carried by a user, for example, on their back, by means of carrying straps 10, in a manner similar to a backpack. In this, the supporting device 9 can comprise a carrying frame that reliably bears the components attached to it. This is also described, for example, in DE 10 2018 118 552 A1 and US20200044206A1.

A rechargeable battery 11 is fastened to the supporting device 9 as an electrical energy storage device. The rechargeable battery 11 represents a central part of the energy device 2 and can be exchangeable and when exhausted, switched out with a fresh rechargeable battery 11.

Instead of the rechargeable battery 11, it is also possible to provide an electrical supply via the public power grid or a power network existing at the construction site.

Furthermore, the supporting device 9 bears a converter 12 which, in particular, converts the current drawn from the rechargeable battery 11, in terms of voltage and frequency, in a manner suitable for the electric motor 5. This converted current is then supplied by the converter 12 to the electric motor 5 via the power line 8.

Symbolically, a measurement device 13 and a vibration device 14 are also arranged on the supporting device 9. The measurement device 13 and the vibration device 14 do not need to be arranged as physically separate components on the supporting device 9. Rather, they can also be arranged in the rechargeable battery 11 or alternatively in the battery management system of the rechargeable battery 11 or also in the converter 12 or also elsewhere.

A mobile device 15, for example, a smart phone or a tablet, is provided in spatially separated manner, in which mobile device an evaluation device 16 can be provided. The measurement device 13 and the evaluation device 16 together form a compaction detection device. In particular, the evaluation device 16 may be installed as a program or alternatively as an app on the mobile device 15.

A transmitting and receiving device 17 is provided on the rechargeable battery 11 for coupling the mobile device 15 with the energy device 2. A data transmission 18 to the mobile device 15 and in particular to the evaluation device 16 can be achieved with the aid of the transmitting and receiving device 17.

The measurement device 13 and the evaluation device 16 together form a compaction detection device for detecting progress of the compaction in the concrete. The measurement device 13 is thus able to monitor the consumption of current of the electric motor 5 during compaction operation. Since modern rechargeable battery systems often comprise a battery management system that very precisely documents the consumption of current, the measurement device 13 can accordingly also be integrated in the rechargeable battery 11 or use the battery management system there. The resulting data is transmitted via data transmission 18, for example, a radio link (Bluetooth), to the mobile device 15 and there to the evaluation device 16. The mobile device 15 provides sufficient computational capacity to allow the evaluation device 16 to perform the necessary calculations. By way of example, the evaluation device 16 can be installed as an app on the mobile device 15 and perform the calculations.

When the evaluation device 16 detects that the progress of the compaction is satisfactory and a prescribed degree of compaction has been achieved, the evaluation device 16 then sends a signal to the vibration device 14. The vibration device 14 is capable of generating a suitable haptic feedback signal that can be haptically perceived by the operator of the internal vibrator. The vibration device 14, likewise, need not be a physically separate component, but rather may be integrated into the other components, in particular, for example, into the converter 12 or alternatively into a control system of the converter 12 that is not shown. It serves only the functional task of generating the haptic feedback signal.

For this purpose, the signal from the evaluation device 16 about the achievement of the prescribed progress of the compaction can be received by the transmitting and receiving device 17 on the rechargeable battery 11 and forwarded to the converter 12, which then increases or reduces the rotational frequency of the electric motor 5. The increase or decrease of the rotational frequency can be done abruptly or continuously or combined with variable time intervals to inform the user about the progress of the compression. For example, it is possible to generate Morse code-like signals by changing the rotational frequency to inform the operator about the progress of the compression.

The change in engine rotational frequency leads to a change in the oscillation frequency of the internal vibrator 1. Since the operator guides the internal vibrator 1 on the operating hose 3 or on the switching device 7 by hand, the change in oscillation frequency is directly perceived as a vibration and can then be interpreted accordingly by the operator.

If the system detects that no further compaction is possible or useful at the current position of the internal vibrator 1 or of the vibrator head 4, a repeating pattern of fluctuating frequencies can be set to signal to the operator that the internal vibrator 1 should be used at a different position. The operator can thereinafter move the vibrator head 4 to an area of still uncompacted concrete using the operating hose 3.

In one variant, the vibration device 14 can, irrespective of a change in engine speed, also generate an independent oscillation similar to the vibrate alarm on a smartphone. For this purpose, the vibration device 14 can activate a small unbalance exciter (not shown), which is provided, for example, on the supporting device 9 or even on the switching device 7, so that the operator can feel the vibration with their back or their hands.

The mobile device 15 is not mandatorily necessary. It is likewise possible to also integrate the evaluation device 16 into the energy device 2, for example, into the battery management system of the rechargeable battery 11, if sufficient computational capacities are available there.

The rechargeable battery 11 can be configured in such a way that it can communicate with the connected converter 12 as well as with the mobile device 15. The necessary measuring devices can be integrated in the rechargeable battery 11 in order to sample the electrical power consumption with sufficient accuracy.

The communication between the rechargeable battery 11 or alternatively the transceiver 17 of the rechargeable battery 11 on the one hand and the mobile device 15 on the other hand is bidirectional, so that the results of the calculations or signals based thereon can be reported back from the external mobile device 15 to the rechargeable battery 11 or also to the converter 12 connected thereto.

As a result, the concrete compaction system is able to tangibly signal to the user that sufficient compaction has been achieved at the current position of the internal vibrator 1 or alternatively of the vibrator head 4. As a result, the compaction process can be carried out efficiently.

1. A concrete compaction system, comprising:
an unbalance exciter that is configured to compact concrete;
a compaction detection device that is configured to detect progress of the compaction of the concrete; and
a vibration device that is configured to generate a haptic feedback upon detection of a prescribed progress of the compaction by the compaction detection device.

2. The concrete compaction system according to claim 1, further comprising
an electric motor that is configured to drive the unbalance exciter;
an electric power supply; and
a converter device that is configured to convert an electric current that is drawn from the electric power supply to a drive current for the electric motor; wherein
the compaction detection device comprises a measurement device that is configured to measure the current drawn from the electric motor; and wherein
the compaction detection device comprises an evaluation device that is configured to 1) evaluate the current draw measured by the measurement device, 2) to determine therefrom a progress of the compaction of the concrete, and 3) to detect whether a prescribed progress of the compaction has been reached.

3. The concrete compaction system according to claim 1, wherein
the unbalance exciter is arranged in a housing; and wherein
an operating hose is fastened to the housing, for guiding the housing by an operator.

4. The concrete compaction system according to claim 1, wherein the electrical power supply comprises an electrical energy storage device.

5. The concrete compaction system according to claim 4, wherein
the electrical energy storage device and the converter device are arranged on a supporting device; and wherein
the supporting device comprises at least one strap that is configured to permit carrying of the supporting device by a user.

6. The concrete compaction system according to claim 1, wherein the vibration device is configured to implement at least one of the following features:
a variation of a speed of the electric motor;
a brief change of a rotational frequency of the electric motor followed by a return to a previous rotational frequency;
a reduction of the rotational frequency of the electric motor to zero;
an abrupt change of the rotational frequency of the electric motor;
a change of a direction of rotation of the electric motor;
multiple changes in the direction of rotation of the electric motor;
generation of a vibration that is perceptible by the operator during operation of the concrete compaction system;
generation of a vibration at the supporting device;
generation of a vibration at the energy storage device;
generation of a vibration at the converter device;
generation of a vibration at the operating hose; and
generation of a vibration at the switching device.

7. The concrete compaction system according to claim 1, wherein the measurement device is coupled to the energy storage device or to the converter device to measure the current.

8. The concrete compaction system according to claim 1, wherein the evaluation device is arranged in a mobile device that is spatially separated from the energy storage device and from the converter device.

9. The concrete compaction system according to claim 1, wherein a data transmission is provided between the measurement device and the evaluation device, for back and forth transmission of data between the measurement device and the evaluation device.

10. A method for concrete compaction, comprising:
immersing an unbalance exciter into the concrete to be compacted;
compacting the concrete by actuating the unbalance exciter;
monitoring the progress of the compaction;
generating a haptic feedback for an operator upon detection of achievement of a prescribed progress of the compaction.

11. The method according to claim 10, wherein the imbalance exciter is driven by an electric motor, and wherein the monitoring comprises
evaluating a measured current draw of the electric motor,
determine therefrom a progress of the compaction in the concrete, and
detecting whether a prescribed progress of the compaction has been reached.

12. The method according to claim 10, further comprising at least one of:
varying a speed of the electric motor;
briefly changing a rotational frequency of the electric motor followed by a return to a previous rotational frequency;
reducing the rotational frequency of the electric motor to zero;
abruptly changing the rotational frequency of the electric motor;
changing a direction of rotation of the electric motor;
changing the direction of rotation of the electric motor multiple times;
generating a vibration that is perceptible by the operator during operation of the concrete compaction system;
generating a vibration at the supporting device;
generating a vibration at the energy storage device;
generating a vibration at the converter device;
generating a vibration at the operating hose; and
generating a vibration at the switching device.
